(19) United States
(12) Patent Application Publication
(10) Pub. No.: US 2014/0183382 A1
(43) Pub. Date: Jul. 3, 2014

(54) DUAL COMPOUND VARIABLE RAM PACKER

(71) Applicant: Hydril USA Manufacturing LLC, Houston, TX (US)

(72) Inventors: William L. Carbaugh, Humble, TX (US); Joseph Alan Incavo, The Woodlands, TX (US); Arturo Caballero, Humble, TX (US); Eugene Chauviere, Houston, TX (US)

(73) Assignee: Hydril USA Manufacturing LLC, Houston, TX (US)

(21) Appl. No.: 13/897,840

(22) Filed: May 20, 2013

Related U.S. Application Data
(60) Provisional application No. 61/747,589, filed on Dec. 31, 2012.

(51) Int. Cl. E21B 33/06; B29C 70/68

(52) U.S. Cl. CPC E21B 33/061; B29C 70/68
USPC 251/1.1; 264/275

(57) ABSTRACT

A variable ram assembly for use in a blowout preventer (BOP) stack includes a packer element. The packer element includes an elastomeric body having a contact surface configured with a curved recess for sealing engaging a tubular. At least a portion of the body adjacent the contact surface is reinforced to define a reinforced area. The reinforced area exerts a restraining force to prevent extrusion of the elastomeric body when it is forced against the tubular. The reinforced area is integrally formed with the body using a molding process.

### CROSS REFERENCE TO RELATED APPLICATIONS

This application claims priority to and the benefit of co-pending U.S. Provisional Application Ser. No. 61/747,589 filed on Dec. 31, 2012, the full disclosure of which is hereby incorporated by reference herein for all purposes.

### BACKGROUND

1. Field of Invention

The present disclosure relates in general to a variable ram packer for use with a blowout preventer (BOP) mounted on a wellhead. More specifically, the present disclosure relates to a variable ram packer with a packer element whose contact surface is reinforced.

2. Description of Prior Art

Wellbores in hydrocarbon bearing subterranean formations are formed by rotating a drill bit mounted on a lower end of a drill string. Typically, a wellhead housing is installed at the earth's surface and through which bit and string are inserted. A blow out preventer (BOP) stack usually mounts on top of the wellhead housing that provides pressure control of the wellbore, and often includes rams to shut in the wellbore should pressure in the wellbore become uncontrollable. Additional rams are often included with BOP stacks that are for shearing the string within the BOP stack, and also for pressure testing within the BOP. Further typically included with BOP stacks are flow lines and valves to allow fluid flow through the BOP stack for remediating overpressure in the wellbore.

One type of BOP ram for pressure testing within a BOP stack is a variable ram packer. Variable ram packers usually include a pair of hydraulically powered rams on opposing lateral sides of the BOP stack, which are selectively forced radially inward into compressive engagement with the tubular. An elastomer packer element is typically provided with the variable ram packers for engaging the tubular, and has a curved recess on its engaging surface for receiving the tubular. The curved recesses on the pair of packers form a seal in the bore and around the tubular so pressure in the wellbore can be verified. Adjacent the curved recess, each packer element often has a planar surface that defines an edge at the interface between the recess and planar surface. During operation of the variable ram packers, compressive stresses in the recess transfer to the unsupported edge portion and extrude it outward. Over time, the edge portion is susceptible to damage from these multiple extrusion cycles, especially during exposure to varying low and high temperatures.

### SUMMARY OF THE INVENTION

Disclosed herein is an example of a variable ram, that in an embodiment includes a ram block selectively moveable within a blowout preventer (BOP) and a ram packer disposed in the ram block. In this example, the ram packer is made up of an elastomer body, a contact surface along a lateral side of the elastomer body, a recess portion on a mid-portion of the contact surface that projects radially into the elastomer body and that is in selective sealing engagement with a tubular in the BOP, and a reinforced area in the elastomer body adjacent the contact surface. Further in this example, the reinforced area has a stiffness greater than a stiffness of the elastomer body, so that when the ram block is moved radially inward into sealing contact with the tubular, the reinforced area exerts a restraining force on the elastomer body. The reinforced area can be made from a material such as neoprene, nitrile rubber, hydrogenated nitrile rubber, carboxylated nitrile rubber, or combinations thereof. In an embodiment, the contact surface adjacent an end of the recess portion is at an angle with respect to the recessed portion to define an edge on the contact surface, and wherein the reinforced area extends adjacent the edge. The elastomer body can be substantially solid, and the reinforced area can extend substantially along a length of the contact surface. In one example, the restraining force on the elastomer body retains the elastomer body in a non-extruded configuration when the ram block is moved radially inward into sealing contact with the tubular.

Also provided herein is a ram packer assembly for use in a blowout preventer (BOP), that in one example is made from an elastomeric body selectively disposed in a ram block. A contact surface is on the body, which has a curved recess that selectively seals against a tubular in the BOP. A reinforced area is integrally formed in the body adjacent the contact surface, so that when the body is forced against the tubular, the reinforced area exerts a force on that opposes extrusion of the body. A series of interlocking inserts may be included that selectively slide with respect to one another on a radial surface of the body when the body is radially compressed. The reinforced area can include neoprene, nitrile rubber, hydrogenated nitrile rubber, carboxylated nitrile rubber, or combinations thereof. The reinforced area can be provided along an interface between an end of the curved recess and an adjacent planar portion of the contact surface. In one optional embodiment, a portion of the body adjacent the reinforced area is stiffer than a portion of the body distal from the reinforced area.

A method is also disclosed that involves forming a ram packer assembly having a contact surface and that is for use in a blowout preventer (BOP). One embodiment of the method includes providing an uncured elastomer, disposing the uncured elastomer into a ram packer assembly mold, inserting the uncured elastomer into the mold, providing a substance for forming a reinforcing material, strategically disposing the substance for forming the reinforcing material in the mold to be adjacent the contact surface, and curing the uncured elastomer to form a body with the reinforced material integrally set in the body to define a reinforced area adjacent the contact surface that has a stiffness greater than a stiffness of the body. The method may further include providing sliding inserts in the mold that mount on opposing surfaces of the body. Optionally, the substance for forming a reinforcing material is a material from the group of neoprene, nitrile rubber, hydrogenated nitrile rubber, and combinations thereof. The body can be included into a ram packer assembly and sealed against a tubular, so that the reinforcing material restrains the body in an unextruded configuration.

### BRIEF DESCRIPTION OF DRAWINGS

Some of the features and benefits of the present invention having been stated, others will become apparent as the description proceeds when taken in conjunction with the accompanying drawings, in which:

FIG. 1 is a perspective view of an example of a variable ram having an embodiment of a packer element in accordance with an embodiment of the present invention.

FIG. 2 is a side partial sectional view of an example of the variable ram of FIG. 1 included in a blowout preventer stack in accordance with an embodiment of the present invention.

FIG. 3 is a perspective view of an example of a packer element of FIG. 1 in accordance with an embodiment of the present invention.

FIG. 4 is a plan view of an alternate embodiment of the packer element of FIG. 1 in accordance with an embodiment of the present invention.

FIG. 5 is a plan view of an example of molding an embodiment of the packer element of FIG. 1 in accordance with an embodiment of the present invention.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

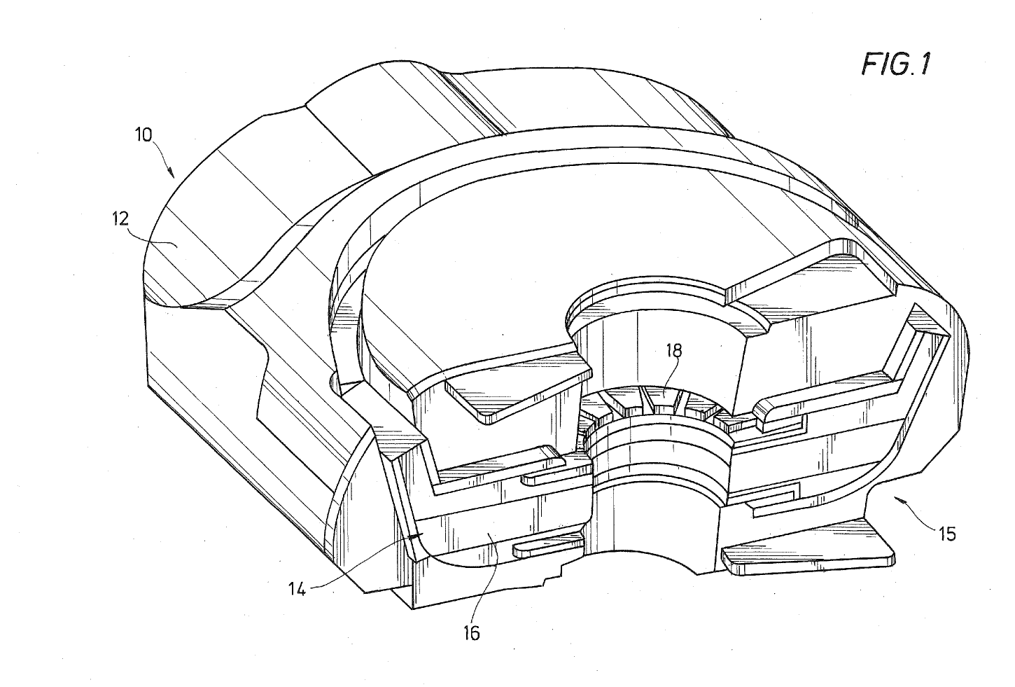

FIG. 1 provides a perspective view of an example embodiment of a variable ram 10, which includes a ram block 12 which houses a ram packer assembly 14. A recess 15 in the ram block 12 is configured to receive the ram packer assembly 14. The recess 15 intersects with a forward facing end of the ram block 12, and extends partially across the width and length of the ram block 12. In the example of FIG. 1, the ram block 12 is a substantially metallic member that is generally rectangular shaped, and where its length and width exceed its height. A packer element 16 makes up part of the packer assembly 14, which in an example is made at least in part from an elastomeric material. Inserts 18 shown set on an upper radial surface of the packer element 16 and arranged in a semi-circle with its outer radius projecting into the recess 15. Brackets at opposing terminal ends of the semi-circle are coupled to the forward facing end of the packer element 16, but the individual inserts 18 are laterally moveable on the radial surface of the packer element 16. Inserts 18 are interlocked on their respective adjoining edges, but slideable towards one another so the semi-circle compresses when the packer element 16 is laterally compressed.

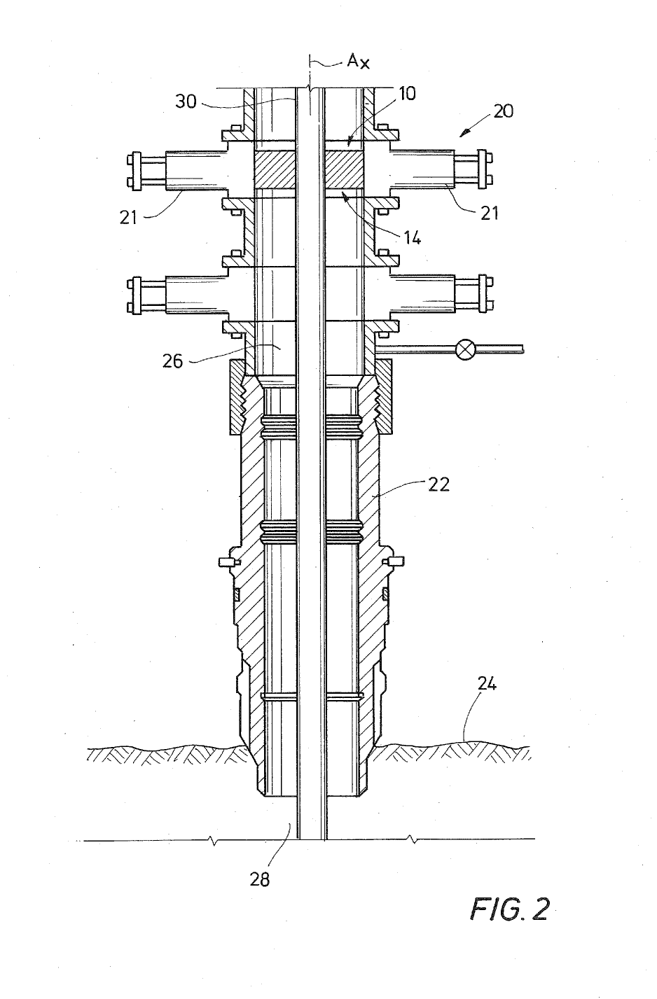

An example of a blowout preventer (BOP) 20 is shown in a side sectional view in FIG. 2 and which includes an embodiment of the variable ram 10. The BOP 20 includes a body 21 for housing a pair of variable rams 10; the variable rams 10 can be selectively actuated laterally in and out of body 21. BOP 20 is shown mounted on an upper end of a wellhead housing 22 that anchors on a surface 24, where surface 24 may be subsea or on land. A main bore 26 through wellhead assembly 22 and BOP 20 is shown registering with a wellbore 28 that is being formed through the surface 24 by a drill string 30. In the example, the drill string 30 extends through the main bore 26 and the wellbore 28, and includes a drill bit (not shown) on its lower end, that when rotated by drill string 30 excavates wellbore 28. As illustrated in the example of FIG. 2, variable rams 10 project radially inward from opposing bodies 21 into sealing engagement with an outer surface of tubular 30. In one example, sealingly engaging the tubular 30 with variable ram allows a pressure test to be performed in wellbore 28.

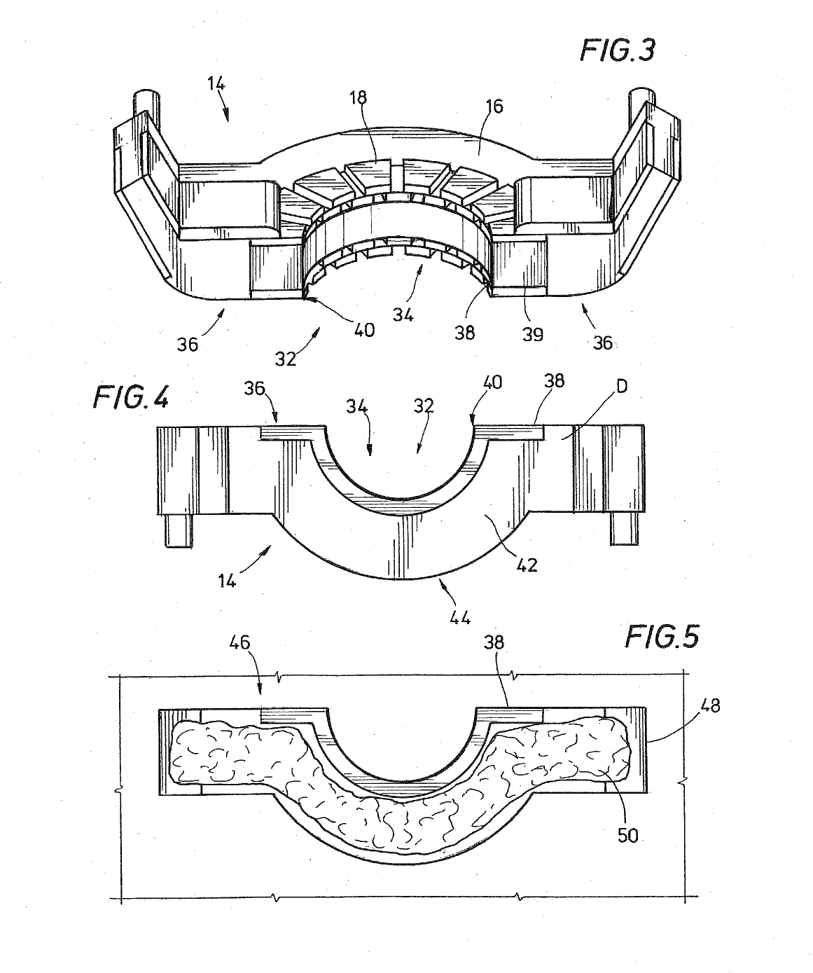

A perspective view of an example of packer assembly 14 is provided in FIG. 3 wherein opposing lateral ends of packer assembly 14 are shown angled upward away from an upper radial surface. A contact surface 32 is defined on the side of the packer element 16 that projects outward from the ram block 12 (FIG. 1) and which includes curved recess 34, which can have a semi-circular or semi-elliptical shape. The curved recess 34 is shown formed along a mid-portion of the contact surface 32 and projects radially inward and follows a generally curved path with its outer radius set adjacent inner radius of the inserts 18. In an example, when the variable ram 10 is urged radially inward as illustrated in FIG. 2, the contact surface 32 is compressed against outer surface of drill string 30. Strategically profiling the curved recess 34 in combination with compressing the contact surface 32 against the drill string 30, forms a sealing surface between packer element 16 and tubular 30 to define an axial pressure barrier in the main bore 26. Adjacent opposing ends of the curved recess 34, the contact surface 32 is disposed in a plane generally parallel with an axis A_{X} of drill string 30 (FIG. 2) thereby defining flats 36 on lateral ends of the curved recess 34.

Further illustrated in the example of FIG. 3 is that the packer element 16 is stiffened and/or strengthened along at least a portion of the contact surface 32 to define a reinforced area 38. In an example, the reinforced area 38 has greater strength and/or stiffness than a remaining portion of the packer element 16. Example properties for quantifying strength and/or stiffness include tensile strength, hardness, modulus of elasticity, yield strength, and percent elongation at breakage. The reinforced area 38 can be formed by treating the packer element 16 proximate the contact surface 32, or disposing a stronger and/or stiffer material 39 to the contact surface 32. In FIG. 3, the reinforced area 38 is shown extending over an interface 40 on the contact surface 32 where curved recess 34 transitions into flat 36. In an example, interface 40 is defined as an edge where the contact surface 32 angles in a radial direction at the boundary between flat 36 and curved recess 34. The reinforced area 38 supports the contact surface 32 and resists extrusion of the interface 40 when the packer element 16 is set in sealing contact with drill string 30 (FIG. 2). Moreover, although the stiffer and/or stronger reinforced area 38 is more resistive to deformation than the packer element 16, the packer assembly 14 can still seal around the drill string 30 (FIG. 2) due to compliant deformation of the more elastic packer element 16.

In an embodiment, the reinforced area 38 includes one or more of neoprene, nitrile rubber, hydronated nitrile rubber, and carboxylated nitrile rubber. Tables 1 and 2 below include example values for properties of the reinforced area 38, or materials making up or included within the reinforced area 38. Examples exist wherein the materials having the properties of Tables 1 and 2 include one or more of hydronated nitrile rubber and carboxylated nitrile rubber.

TABLE 1

| | Value | Range 1 | Range 2 | Range 3 |
|---|---|---|---|---|
| % Elongation at failure | 731 | 681-781 | 656-806 | 631-831 |
| 100% Modulus (psi) | 323 | 273-373 | 248-398 | 223-423 |
| Tensile Strength (psi) | 3132 | 3032-3232 | 2982-3282 | 2932-3332 |
| Hardness | 75 | 70-80 | 65-85 | 60-90 |

TABLE 2

| | Value | Range 1 | Range 2 | Range 3 |
|---|---|---|---|---|
| % Elongation at failure | 369 | 319-419 | 294-444 | 269-469 |
| 100% Modulus (psi) | 1251 | 1201-1301 | 1151-1351 | 1101-1401 |
| Tensile Strength (psi) | 3630 | 3530-3730 | 3480-3780 | 3430-3830 |
| Hardness | 85 | 80-90 | 75-95 | 70-100 |

FIG. 4 illustrates an alternate embodiment of the packer assembly 14 shown in a plan view, wherein the reinforced area 38 extends onto the upper radial surface 42. More specifically, in the example of FIG. 4, the reinforced area 38 extends a distance D from a contact surface 32 of packer assembly 14 on the upper radial surface 42. Further, the reinforced area 38 is provided along substantially all of the curved recess 34 and approximately to a midpoint between terminal ends of the packer assembly 14 along the flat portion 36. Optionally however, embodiments exist wherein the reinforced area 38 is concentrated at or adjacent to the interface 40 between the curved recess 34 and flat 36. In another optional embodiment, the reinforced area 38 extends along the entire or substantially entire surface of contact surface 32. Further illustrated in FIG. 4 is a rearward surface 44 of the packer assembly 14 that is curved and projects radially outward from the contact surface 32.

One example of forming a packer element 16 is shown in FIG. 5. In this example, a mold 46 is provided having sidewalls 48 that approximate the outer periphery of the packer element 16 (FIG. 3). In this example, an amount of uncured elastomer 50 is provided within the mold 46, and in an amount to substantially fill the mold 46 when cured in the mold. Included with the uncured elastomer 50 is an example of material making up the reinforced area 38 shown set along an inside of sidewall 48 adjacent where the contact surface 32 (FIG. 3) will be located on completion of the formation process. As is known, the mold 46 is enclosed and subjected to increased temperature and/or pressure for a period of time until the uncured elastomer 50 cures and transforms into the packer element 16. In one optional example, a precursor or uncured material is set in the mold 46 that is transformed into the reinforced area 38 during the formation/curing process. Thus in one example, disposing the material that forms the reinforced area 38 along with the uncured elastomer 50 integrates the finally formed reinforced area 38 with the packer element 16 during the curing process to produce a uni-body element. Furthermore, the process illustrated in FIG. 5 can in one example create a substantially solid packer element 16.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A variable ram comprising:
a ram block selectively moveable within a blowout preventer (BOP); and
a ram packer disposed in the ram block comprising,
an elastomer body,
a contact surface along a lateral side of the elastomer body,
a recess portion on a mid-portion of the contact surface that projects radially into the elastomer body and that is in selective sealing engagement with a tubular in the BOP, and
a reinforced area in the elastomer body adjacent the contact surface and having a stiffness greater than a stiffness of the elastomer body, so that when the ram block is moved radially inward into sealing contact with the tubular, the reinforced area exerts a restraining force on the elastomer body.

2. The variable ram of claim 1, wherein the reinforced area comprises a material selected from the group consisting of neoprene, nitrile rubber, hydrogenated nitrile rubber, carboxylated nitrile rubber, and combinations thereof.

3. The variable ram of claim 1, wherein the contact surface adjacent an end of the recess portion is at an angle with respect to the recessed portion to define an edge on the contact surface, and wherein the reinforced area extend adjacent the edge.

4. The variable ram of claim 1, wherein the elastomer body is substantially solid.

5. The variable ram of claim 1, wherein the reinforced area extends substantially along a length of the contact surface.

6. The variable ram of claim 1, wherein the restraining force on the elastomer body retains the elastomer body in a non-extruded configuration when the ram block is moved radially inward into sealing contact with the tubular.

7. A ram packer assembly for use in a blowout preventer (BOP) comprising:
a body comprising an elastomeric material and selectively disposed in a ram block;
a contact surface on the body having a curved recess that selectively seals against a tubular in the BOP; and
a reinforced area integrally formed in the body adjacent the contact surface, so that when the body is forced against the tubular, the reinforced area exerts a force on that opposes extrusion of the body.

8. The ram packer assembly of claim 7, further comprising a series of interlocking inserts that selectively slide with respect to one another on a radial surface of the body when the body is radially compressed.

9. The ram packer assembly of claim 7, wherein the reinforced area comprises a material selected from the group consisting of neoprene, nitrile rubber, hydrogenated nitrile rubber, carboxylated nitrile rubber, and combinations thereof.

10. The ram packer assembly of claim 7, wherein the reinforced area is provided along an interface between an end of the curved recess and an adjacent planar portion of the contact surface.

11. The ram packer assembly of claim 7, wherein a portion of the body adjacent the reinforced area is stiffer than a portion of the body distal from the reinforced area.

12. A method of forming a ram packer assembly having a contact surface and that is for use in a blowout preventer (BOP), the method comprising:
a. providing an uncured elastomer;
b. disposing the uncured elastomer into a ram packer assembly mold;
c. inserting the uncured elastomer into the mold;
d. providing a substance for forming a reinforcing material;
e. strategically disposing the substance for forming a reinforcing material in the mold to be adjacent the contact surface; and
f. curing the uncured elastomer to form a body with the reinforced material integrally set in the body to define a reinforced area adjacent the contact surface that has a stiffness greater than a stiffness of the body.

13. The method of claim 12, further comprising providing sliding inserts in the mold that mount on opposing surfaces of the body.

14. The method of claim 12, wherein the substance for forming a reinforcing material comprises a material selected from the group consisting of neoprene, nitrile rubber, hydrogenated nitrile rubber, and combinations thereof.

15. The method of claim 12, wherein when the body is included into a ram packer assembly and sealed against a tubular, the reinforcing material restrains the body in an unextruded configuration.
